(19) United States
(12) Patent Application Publication
(10) Pub. No.: US 2022/0004635 A1
(43) Pub. Date: Jan. 6, 2022

(54) COMPUTING PERIPHERAL INTERFACE MANAGEMENT MECHANISM

(71) Applicant: Intel Corporation, Santa Clara, CA (US)

(72) Inventors: Daniel Nemiroff, El Dorado Hills, CA (US); Vidhya Krishnan, Chandler, AZ (US); Bryan R. White, Folsom, CA (US)

(73) Assignee: Intel Corporation, Santa Clara, CA (US)

(21) Appl. No.: 17/480,601

(22) Filed: Sep. 21, 2021

(51) Int. Cl. G06F 21/57; G06F 13/10; G06F 21/72

(52) U.S. Cl. CPC G06F 21/57; G06F 13/102; G06F 21/76; G06F 2221/034; G06F 21/72

(57) ABSTRACT

An apparatus is disclosed. The apparatus comprises a trusted device including a first integrated circuit (IC) die comprising a first plurality of hardware devices and a second IC die comprising a second plurality of hardware devices and cryptographic processor to operate as a root of trust to manage an input/output (I/O) functional state of each of the hardware devices.

### BACKGROUND OF THE DESCRIPTION

A system on chip (SOC) is an integrated circuit that integrates all components of a computer or other electronic system. These components include a central processing unit (CPU), memory, input/output (10) ports and secondary storage, which are all included on a single substrate or microchip.

### BRIEF DESCRIPTION OF THE DRAWINGS

So that the manner in which the above recited features of the present embodiment can be understood in detail, a more particular description of the embodiment, briefly summarized above, may be had by reference to embodiments, some of which are illustrated in the appended drawings. It is to be noted, however, that the appended drawings illustrate only typical embodiments of this embodiment and are therefore not to be considered limiting of its scope, for the embodiment may admit to other equally effective embodiments.

FIG. 1 illustrates one embodiment of a computing device.

FIG. 2 illustrates one embodiment of a platform.

FIG. 3 illustrates one embodiment of a SOC.

FIG. 4 illustrates one embodiment of trusted input/output registers.

FIG. 5 is a flow diagram illustrating one embodiment of a process for performing a trusted input/output process.

FIG. 6 illustrates one embodiment of a schematic diagram of an illustrative electronic computing device.

### DETAILED DESCRIPTION

In the following description, numerous specific details are set forth to provide a more thorough understanding of the present embodiment. However, it will be apparent to one of skill in the art that the present embodiment may be practiced h one or more of these specific details. In other instances, well-known features have not been described in order to avoid obscuring the present embodiment.

In embodiments, a mechanism is provided to manage a device in a trusted input/output (I/O) environment having multiple integrated circuit (IC) die components (or chiplets).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to and are not intended to imply that the elements so described must be in a given sequence, either temporally, spatially, in ranking, or in any other manner.

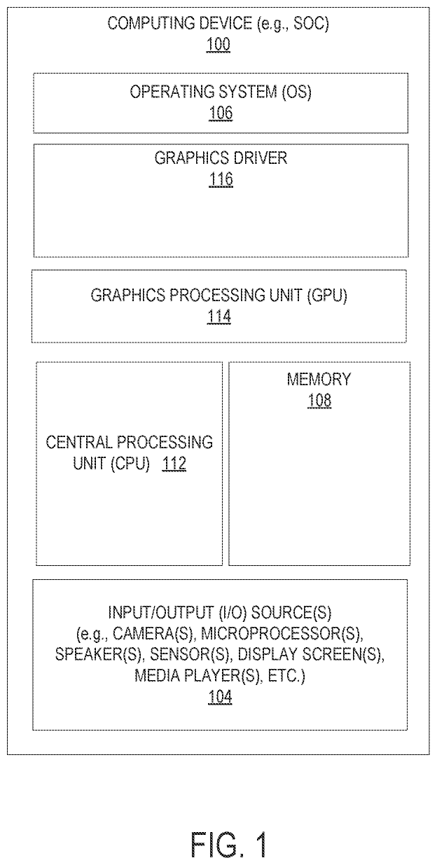

FIG. 1 illustrates one embodiment of a computing device 100. According to one embodiment, computing device 100 comprises a computer platform hosting an integrated circuit (“IC”), such as a system on a chip (“SoC” or “SOC”), integrating various hardware and/or software components of computing device 100 on a single chip. As illustrated, in one embodiment, computing device 100 may include any number and type of hardware and/or software components, such as (without limitation) graphics processing unit 114 (“GPU” or simply “graphics processor”), graphics driver 116 (also referred to as “GPU driver”, “graphics driver logic”, “driver logic”, user-mode driver (UMD), UMD, user-mode driver framework (UMDF), UMDF, or simply “driver”), central processing unit 112 (“CPU” or simply “application processor”), memory 108, network devices, drivers, or the like, as well as input/output (I/O) sources 104, such as touchscreens, touch panels, touch pads, virtual or regular keyboards, virtual or regular mice, ports, connectors, etc. Computing device 100 may include operating system (OS) 106 serving as an interface between hardware and/or physical resources of computing device 100 and a user.

It is to be appreciated that a lesser or more equipped system than the example described above may be preferred for certain implementations. Therefore, the configuration of computing device 100 may vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The terms “logic”, “module”, “component”, “engine”, and “mechanism” may include, by way of example, software or hardware and/or a combination thereof, such as firmware.

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

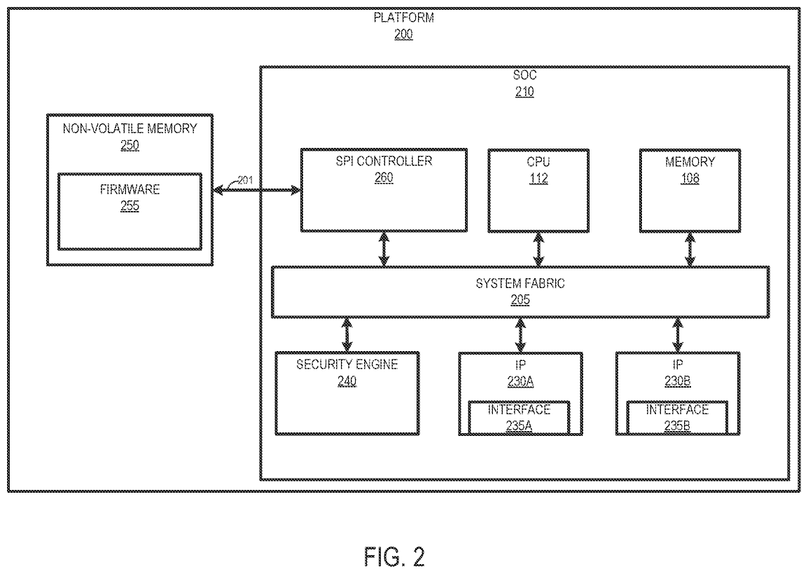

FIG. 2 illustrates one embodiment of a platform 200 including a SOC 210 similar to computing device 100 discussed above. As shown in FIG. 2, SOC 210 includes other computing device components (e.g., memory 108 and CPU 112) coupled via a system fabric 205. In one embodiment, system fabric 205 comprises an integrated on-chip system fabric (IOSF) to provide a standardized on-die interconnect protocol for coupling interconnect protocol (IP) agents 230 (e.g., IP agents 230A and 230B) within SOC 210. In such an embodiment, the interconnect protocol provides a standardized interface to enable third parties to design logic such as IP agents to be incorporated in SOC 210.

According to embodiment, IP agents 230 may include general purpose processors (e.g., in-order or out-of-order cores), fixed function units, graphics processors, I/O controllers, display controllers, etc. In such an embodiment, each IP agent 230 includes a hardware interface 235 (e.g., 235A and 235B) to provide standardization to enable the IP agent 230 to communicate with SOC 210 components. For example, in an embodiment in which IP agent 230 is a third-party visual processing unit (VPU), interface 235 provides a standardization to enable the VPU to access memory 108 via fabric 205.

Further, SOC 210 is coupled to a non-volatile memory 250. Non-volatile memory 250 may be implemented as a Peripheral Component Interconnect Express (PCIe) storage drive, such as a solid-state drive (SSD) or Non-Volatile Memory Express (NVMe) drives. In one embodiment, non-volatile memory 250 is implemented to store the platform 200 firmware 255. In one embodiment, SOC 210 is coupled to non-volatile memory 250 via a serial peripheral interface (SPI) 201. In such an embodiment, SOC 210 includes SPI controller 260 coupled between SPI 201 and system fabric 205. In a further embodiment, SPI controller 260 is a flash controller implemented to control access to non-volatile memory 250 via SPI 201.

SOC 210 also includes a security engine 240 that performs various security operations (e.g., security processing, cryptographic functions, etc.) for SOC 210. In one embodiment, security engine 240 comprises an IP agent 230 that is implemented to perform the security operations. In one embodiment, security engine 240 is a cryptographic processor that operates as a root of trust (or platform ROT) to assure the integrity of hardware and software operating on platform 200. As used herein, a ROT is defined as a set of functions in a trusted computing module within a host that is always trusted by the host's operating system (OS). The ROT serves as separate compute engine controlling the trusted computing platform cryptographic processor, such as security engine 240, on platform 200.

Trusted I/O (such as Trust Domain Extensions (TDX) I/O) enables a device to be securely assigned to a trusted domain such that the data on a communication link is protected for confidentiality, integrity and against replay attacks. Thus, a trusted I/O solution requires all capabilities within a device to be assigned to a trusted entity on a host (e.g., CPU 112) to manage functional and error state changes. The mechanism by which a peripheral device's root of trust coordinates the assignment of device resources for the purpose of assignment to a host is based a trusted I/O ROT.

According to one embodiment, a security engine is provided to manage multiple devices on one or more IC die within a SOC. In a further embodiment, a plurality of trusted I/O interface states and an error management status is placed within each hardware device within the SOC and/or IC die components. In such an embodiment, a SOC security engine operates as the ROT that ensures that all hardware devices across all IC die enter and exit a trusted I/O functional state in coordination with a host. In yet a further embodiment, each hardware device includes error handling logic to detect security violations and signal the violations to the security engine in order to inform a trusted host entity and to exit the trusted I/O state.

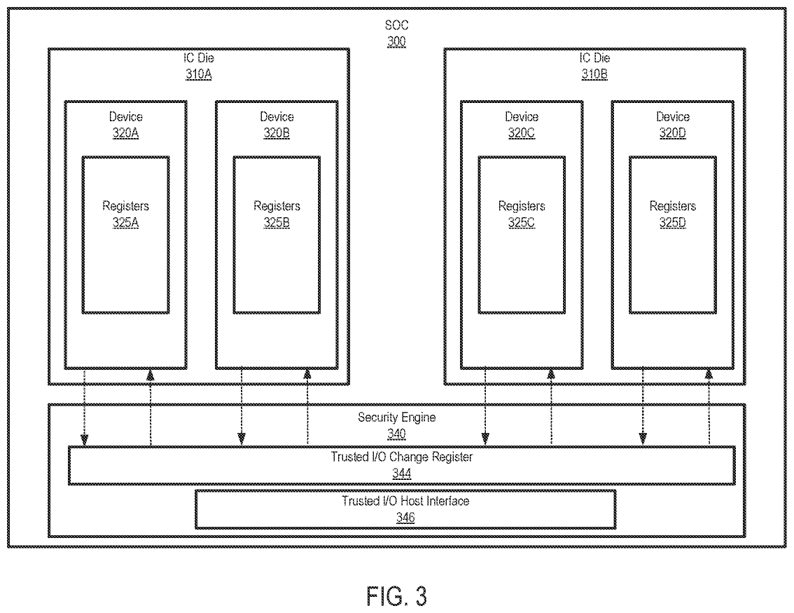

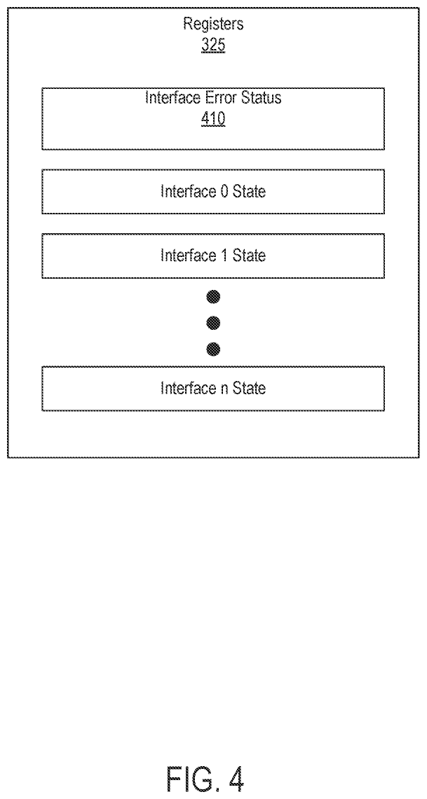

FIG. 3 illustrates one embodiment of a SOC 300. In one embodiment, SOC 300 comprises a trusted I/O environment that includes a plurality of IC die 310 (e.g., 310A and 310B) and security engine 340. Each IC die 310 includes one or more hardware devices (or devices) 320. For example, IC die 310A includes devices 320A and 320B, while IC die 310B includes devices 320C and 320D. In a further embodiment, each hardware device comprises an IP 230 described in FIG. 2. In yet a further embodiment, each device 320 includes a set of trusted I/O registers 325 (e.g., registers 325A, 325B, 325C and 325D). FIG. 4 illustrates one embodiment of trusted I/O registers 325.

As shown in FIG. 4, I/O registers 325 include interface state registers (e.g., 0-n) and an interface error status register 410. In one embodiment, each interface state register maintains an I/O state. In one embodiment, states stored in each register include lock, unlock, DMA, DMA+MMIO and error states. When in the lock, DMA or DMA+MMIO state, any illegal configuration change to the device by untrusted software will place the device into an Interface Error state. Interface error status register 410 is implemented to store an error status. In one embodiment, each device 320 monitors for security violations as defined by a trusted I/O specification upon being entered into a trusted I/O operational state. Upon detection of a security violation, the device 320 stores a value associated with a detected security violation within its register 410 and transmits an alert to security engine 340 indicating that the security violation has been detected. In one embodiment, a violation is detected by memory mapped I/O to I/O addresses outside a trusted range, memory outside the trusted range, DMAs to memory outside the trusted range or configuration changes such as writes by untrusted software to the PCI configuration space of the device.

Referring back to FIG. 3, security engine 340 comprises a hardware ROT that includes a trusted I/O change register 344 and a trusted I/O host interface 346 to interface with the host. Prior to executing trusted I/O operations, security engine 340 receives a request via host interface 346 indicating that SOC 300 is to enter a trusted state. In responding to the request, security engine 340 sets the state of each device 320 to a trusted I/O operational state by programming the interface state registers within each device 320. This process is repeated for each IC die 310 within SOC 300.

Trusted I/O change register 344 is implemented to receive status violations from each device 320. Upon receiving an alert from a device 320, security engine 340 queries the register 410 within each device to determine at which device 320 violation occurred. Thus, trusted I/O change register 344 does not contain any information specific to the device 320 or die 310 in which a violation occurred. This allows SOC 300 to scale the number and type of devices 320 and number of die 310 without having to modify security engine 340, as well as avoid race conditions where multiple devices 320 may be simultaneously writing to trusted I/O change register 344.

Upon querying the register 410 each device 320, security engine 340 determines hardware devices 320 that detected a security violation based on values stored within one or more registers 410 indicating that a security violation has been detected. Subsequently, security engine 340 transmits a cryptographically protected message informing the host of the information. In one embodiment, security engine 340 subsequently facilitates an exit of the particular device 320 from the trusted I/O operational state. However, in other embodiments, security engine 340 may facilitate the exit of all devices 320 within SOC 300 from the trusted I/O operational state.

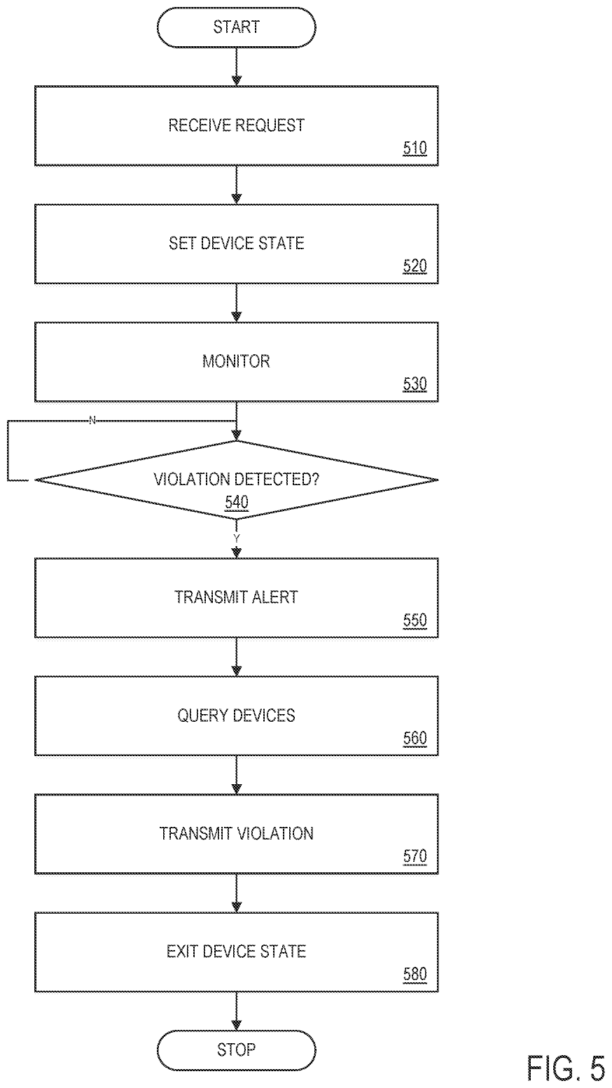

FIG. 5 is a flow diagram illustrating one embodiment of a process for performing a trusted I/O process. At processing block 510, the security engine receives a request from a trusted host to enter the SOC (or trusted device) into a trusted I/O operational state. At processing block 520, the security engine sets the state of each device in the SOC to enter a trusted I/O operational state. As discussed above, the state is changed by programming the interface state register within each device 320.

At processing block 530, each device begins to monitor for a security violation. At decision block 540, a determination is made as to whether a security violation has been detected by one or more of the devices. If not, control is returned to decision block 540. Otherwise, an alert is transmitted by the one or more of the devices to the security engine, processing block 550. At processing block 560, the security engine queries the devices the interface error status register at each device to determine which device has detected the violation. At processing block 570, the security engine transmits the violation to the host, which exits the trusted I/O state. At processing block 580, the device at which the security violation was detected exit the trusted I/O operational state.

Although discussed above with reference to managing multiple devices IC die within a SOC, other embodiments of the above-described mechanism may be implemented to manage devices on different IC die within multiple SOC packages.

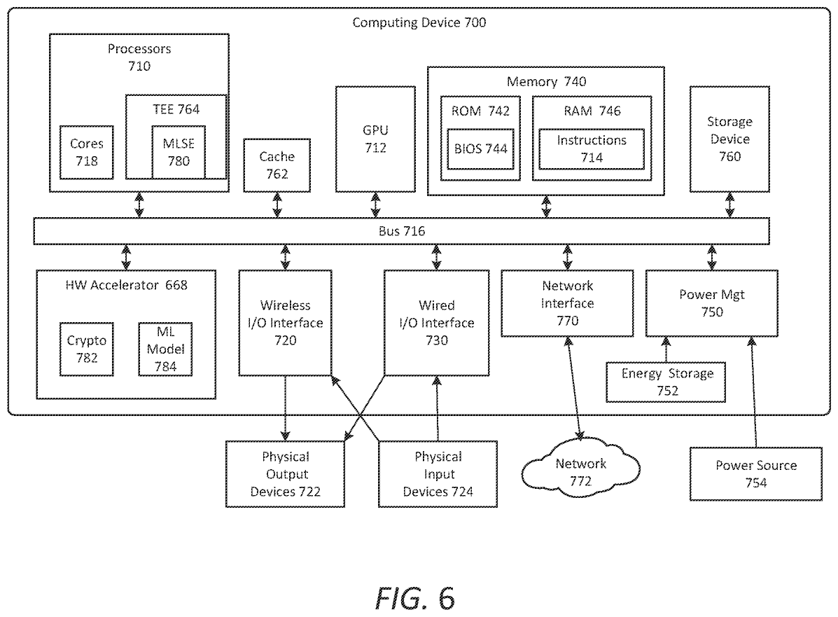

FIG. 6 is a schematic diagram of an illustrative electronic computing device to enable enhanced protection against adversarial attacks according to some embodiments. In some embodiments, the computing device 700 includes one or more processors 710 including one or more processors cores 718 and a TEE 764, the TEE including a machine learning service enclave (MLSE) 780. In some embodiments, the computing device 700 includes a hardware accelerator 768, the hardware accelerator including a cryptographic engine 782 and a machine learning model 784. In some embodiments, the computing device is to provide enhanced protections against ML adversarial attacks, as provided in FIGS. 1-5.

The computing device 700 may additionally include one or more of the following: cache 762, a graphical processing unit (GPU) 712 (which may be the hardware accelerator in some implementations), a wireless input/output (I/O) interface 720, a wired I/O interface 730, memory circuitry 740, power management circuitry 750, non-transitory storage device 760, and a network interface 770 for connection to a network 772. The following discussion provides a brief, general description of the components forming the illustrative computing device 700. Example, non-limiting computing devices 700 may include a desktop computing device, blade server device, workstation, or similar device or system.

In embodiments, the processor cores 718 are capable of executing machine-readable instruction sets 714, reading data and/or instruction sets 714 from one or more storage devices 760 and writing data to the one or more storage devices 760. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like.

The processor cores 718 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions.

The computing device 700 includes a bus or similar communications link 716 that communicably couples and facilitates the exchange of information and/or data between various system components including the processor cores 718, the cache 762, the graphics processor circuitry 712, one or more wireless I/O interfaces 720, one or more wired I/O interfaces 730, one or more storage devices 760, and/or one or more network interfaces 770. The computing device 700 may be referred to in the singular herein, but this is not intended to limit the embodiments to a single computing device 700, since in certain embodiments, there may be more than one computing device 700 that incorporates, includes, or contains any number of communicably coupled, collocated, or remote networked circuits or devices.

The processor cores 718 may include any number, type, or combination of currently available or future developed devices capable of executing machine-readable instruction sets.

The processor cores 718 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 6 are of conventional design. Consequently, such blocks need not be described in further detail herein, as they will be understood by those skilled in the relevant art. The bus 716 that interconnects at least some of the components of the computing device 700 may employ any currently available or future developed serial or parallel bus structures or architectures.

The system memory 740 may include read-only memory (“ROM”) 742 and random-access memory (“RAM”) 746. A portion of the ROM 742 may be used to store or otherwise retain a basic input/output system (“BIOS”) 744. The BIOS 744 provides basic functionality to the computing device 700, for example by causing the processor cores 718 to load and/or execute one or more machine-readable instruction sets 714. In embodiments, at least some of the one or more machine-readable instruction sets 714 cause at least a portion of the processor cores 718 to provide, create, produce, transition, and/or function as a dedicated, specific, and particular machine, for example a word processing machine, a digital image acquisition machine, a media playing machine, a gaming system, a communications device, a smartphone, or similar.

The computing device 700 may include at least one wireless input/output (I/O) interface 720. The at least one wireless I/O interface 720 may be communicably coupled to one or more physical output devices 722 (tactile devices, video displays, audio output devices, hardcopy output devices, etc.). The at least one wireless I/O interface 720 may communicably couple to one or more physical input devices 724 (pointing devices, touchscreens, keyboards, tactile devices, etc.). The at least one wireless I/O interface 720 may include any currently available or future developed wireless I/O interface. Example wireless I/O interfaces include, but are not limited to: BLUETOOTH®, near field communication (NFC), and similar.

The computing device 700 may include one or more wired input/output (I/O) interfaces 730. The at least one wired I/O interface 730 may be communicably coupled to one or more physical output devices 722 (tactile devices, video displays, audio output devices, hardcopy output devices, etc.). The at least one wired I/O interface 730 may be communicably coupled to one or more physical input devices 724 (pointing devices, touchscreens, keyboards, tactile devices, etc.). The wired I/O interface 730 may include any currently available or future developed I/O interface. Example wired I/O interfaces include but are not limited to: universal serial bus (USB), IEEE 1394 (“FireWire”), and similar.

The computing device 700 may include one or more communicably coupled, non-transitory, data storage devices 760. The data storage devices 760 may include one or more hard disk drives (HDDs) and/or one or more solid-state storage devices (SSDs). The one or more data storage devices 760 may include any current or future developed storage appliances, network storage devices, and/or systems. Non-limiting examples of such data storage devices 760 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 760 may include one or more removable storage devices, such as one or more flash drives, flash memories, flash storage units, or similar appliances or devices capable of communicable coupling to and decoupling from the computing device 700.

The one or more data storage devices 760 may include interfaces or controllers (not shown) communicatively coupling the respective storage device or system to the bus 716. The one or more data storage devices 760 may store, retain, or otherwise contain machine-readable instruction sets, data structures, program modules, data stores, databases, logical structures, and/or other data useful to the processor cores 718 and/or graphics processor circuitry 712 and/or one or more applications executed on or by the processor cores 718 and/or graphics processor circuitry 712. In some instances, one or more data storage devices 760 may be communicably coupled to the processor cores 718, for example via the bus 716 or via one or more wired communications interfaces 730 (e.g., Universal Serial Bus or USB); one or more wireless communications interfaces 720 (e.g., Bluetooth®, Near Field Communication or NFC); and/or one or more network interfaces 770 (IEEE 802.3 or Ethernet, IEEE 802.11, or Wi-Fi®, etc.).

Processor-readable instruction sets 714 and other programs, applications, logic sets, and/or modules may be stored in whole or in part in the system memory 740. Such instruction sets 714 may be transferred, in whole or in part, from the one or more data storage devices 760. The instruction sets 714 may be loaded, stored, or otherwise retained in system memory 740, in whole or in part, during execution by the processor cores 718 and/or graphics processor circuitry 712.

The computing device 700 may include power management circuitry 750 that controls one or more operational aspects of the energy storage device 752. In embodiments, the energy storage device 752 may include one or more primary (i.e., non-rechargeable) or secondary (i.e., rechargeable) batteries or similar energy storage devices.

In embodiments, the energy storage device 752 may include one or more supercapacitors or ultracapacitors. In embodiments, the power management circuitry 750 may alter, adjust, or control the flow of energy from an external power source 754 to the energy storage device 752 and/or to the computing device 700. The power source 754 may include, but is not limited to, a solar power system, a commercial electric grid, a portable generator, an external energy storage device, or any combination thereof.

For convenience, the processor cores 718, the graphics processor circuitry 712, the wireless I/O interface 720, the wired I/O interface 730, the storage device 760, and the network interface 770 are illustrated as communicatively coupled to each other via the bus 716, thereby providing connectivity between the above-described components. In alternative embodiments, the above-described components may be communicatively coupled in a different manner than illustrated in FIG. 6. For example, one or more of the above-described components may be directly coupled to other components, or may be coupled to each other, via one or more intermediary components (not shown). In another example, one or more of the above-described components may be integrated into the processor cores 718 and/or the graphics processor circuitry 712. In some embodiments, all or a portion of the bus 716 may be omitted and the components are coupled directly to each other using suitable wired or wireless connections.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Some embodiments pertain to Example 1 that includes an apparatus comprising a trusted device including a first integrated circuit (IC) die comprising a first plurality of hardware devices and a second IC die comprising a second plurality of hardware devices and cryptographic processor to operate as a root of trust to manage an input/output (I/O) functional state of each of the hardware devices.

Example 2 includes the subject matter of Example 1, wherein the first and second plurality of hardware devices each include trusted I/O registers.

Example 3 includes the subject matter of Examples 1 and 2, wherein the trusted I/O registers comprise at least one interface state registers and an error status register.

Example 4 includes the subject matter of Examples 1-3, wherein the cryptographic processor receives a request from a host indicating that the trusted device is to enter a trusted state.

Example 5 includes the subject matter of Examples 1-4, wherein the cryptographic processor programs the interface state registers within each of the first and second plurality of hardware devices to enter the first and second plurality of hardware devices into a trusted I/O operational state.

Example 6 includes the subject matter of Examples 1-5, wherein each of the first and second plurality of hardware devices performs error handling to detect security violations upon being entered into the trusted I/O operational state.

Example 7 includes the subject matter of Examples 1-6, wherein a hardware device stores a value associated with a detected security violation within the error status register upon detecting the security violation.

Example 8 includes the subject matter of Examples 1-7, wherein the hardware device transmits an alert to the cryptographic processor indicating that the security violation has been detected.

Example 9 includes the subject matter of Examples 1-8, wherein the cryptographic processor queries the error status register within each of the first and second plurality of hardware devices to determine the hardware device at which the error security violation has been detected.

Example 10 includes the subject matter of Examples 1-9, wherein the cryptographic processor transmits a message to the host indicating the hardware device that detected the security violation.

Example 11 includes the subject matter of Examples 1-10, wherein the cryptographic processor facilitates an exit of the trusted device from the trusted I/O operational state.

Some embodiments pertain to Example 12 that includes a method comprising receiving a request from a host indicating that each of a plurality of hardware devices within a system on chip (SOC) is to enter into a trusted input/output (I/O) operational state and programming state registers within each of the plurality of hardware devices to enter the plurality hardware devices into a trusted I/O operational state.

Example 13 includes the subject matter of Example 12, further comprising receiving an alert indicating that a security violation has been detected at one or more of the plurality of hardware devices.

Example 14 includes the subject matter of Examples 12 and 13, further comprising querying an error status register within each of the plurality of hardware devices to determine the hardware device at which the security violation has been detected and determining that the error status register within a first of the plurality of hardware devices includes a value indicating that the security violation has been detected.

Example 15 includes the subject matter of Examples 12-14, further comprising transmitting a cryptographically protected message to the host indicating that the first hardware device has detected the security violation.

Example 16 includes the subject matter of Examples 12-15, further comprising facilitating an exit of the first hardware device from the trusted I/O operational state.

Some embodiments pertain to Example 17 that includes at least one computer readable medium having instructions stored thereon, which when executed by one or more processors, cause the processors to receive a request from a host indicating that each of a plurality of hardware devices within a system on chip (SOC) is to enter into a trusted input/output (I/O) operational state and program state registers within each of the plurality of hardware devices to enter the plurality hardware devices into a trusted I/O operational state.

Example 18 includes the subject matter of Example 17, which when executed by the one or more processors, further cause the processors to receive an alert indicating that a security violation has been detected at one or more of the plurality of hardware devices.

Example 19 includes the subject matter of Examples 17 and 18, which when executed by the one or more processors, further cause the processors to query an error status register within each of the plurality of hardware devices to determine the hardware device at which the security violation has been detected and determine that the error status register within a first of the plurality of hardware devices includes a value indicating that the security violation has been detected.

Example 20 includes the subject matter of Examples 17-19, which when executed by one or more processors, further cause the processors to transmit a cryptographically protected message to the host indicating that the first hardware device has detected the security violation and facilitate an exit of the first hardware device from the trusted I/O operational state.

The embodiment has been described above with reference to specific embodiments. Persons skilled in the art, however, will understand that various modifications and changes may be made thereto without departing from the broader spirit and scope of the embodiment as set forth in the appended claims. The foregoing description and drawings are, accordingly, to be regarded in an illustrative rather than a restrictive sense.

What is claimed is:

1. An apparatus comprising:
a trusted device including:
a first integrated circuit (IC) die comprising a first plurality of hardware devices; and
a second IC die comprising a second plurality of hardware devices; and
cryptographic processor to operate as a root of trust to manage an input/output (I/O) functional state of each of the hardware devices.

2. The apparatus of claim 1, wherein the first and second plurality of hardware devices each include trusted I/O registers.

3. The apparatus of claim 2, wherein the trusted I/O registers comprise:
at least one interface state registers; and
an error status register.

4. The apparatus of claim 3, wherein the cryptographic processor receives a request from a host indicating that the trusted device is to enter a trusted state.

5. The apparatus of claim 4, wherein the cryptographic processor programs the interface state registers within each of the first and second plurality of hardware devices to enter the first and second plurality of hardware devices into a trusted I/O operational state.

6. The apparatus of claim 5, wherein each of the first and second plurality of hardware devices performs error handling to detect security violations upon being entered into the trusted I/O operational state.

7. The apparatus of claim 6, wherein a hardware device stores a value associated with a detected security violation within the error status register upon detecting the security violation.

8. The apparatus of claim 7, wherein the hardware device transmits an alert to the cryptographic processor indicating that the security violation has been detected.

9. The apparatus of claim 8, wherein the cryptographic processor queries the error status register within each of the first and second plurality of hardware devices to determine the hardware device at which the error security violation has been detected.

10. The apparatus of claim 9, wherein the cryptographic processor transmits a message to the host indicating the hardware device that detected the security violation.

11. The apparatus of claim 9, wherein the cryptographic processor facilitates an exit of the trusted device from the trusted I/O operational state.

12. A method comprising:
receiving a request from a host indicating that each of a plurality of hardware devices within a system on chip (SOC) is to enter into a trusted input/output (I/O) operational state; and
programming state registers within each of the plurality of hardware devices to enter the plurality hardware devices into a trusted I/O operational state.

13. The method of claim 12, further comprising receiving an alert indicating that a security violation has been detected at one or more of the plurality of hardware devices.

14. The method of claim 13, further comprising:
querying an error status register within each of the plurality of hardware devices to determine the hardware device at which the security violation has been detected; and
determining that the error status register within a first of the plurality of hardware devices includes a value indicating that the security violation has been detected.

15. The method of claim 14, further comprising transmitting a cryptographically protected message to the host indicating that the first hardware device has detected the security violation.

16. The method of claim 15, further comprising facilitating an exit of the first hardware device from the trusted I/O operational state.

17. At least one computer readable medium having instructions stored thereon, which when executed by one or more processors, cause the processors to:
receive a request from a host indicating that each of a plurality of hardware devices within a system on chip (SOC) is to enter into a trusted input/output (I/O) operational state; and
program state registers within each of the plurality of hardware devices to enter the plurality hardware devices into a trusted I/O operational state.

18. The computer readable medium of claim 17, which when executed by the one or more processors, further cause the processors to receive an alert indicating that a security violation has been detected at one or more of the plurality of hardware devices.

19. The computer readable medium of claim 18, which when executed by the one or more processors, further cause the processors to:
query an error status register within each of the plurality of hardware devices to determine the hardware device at which the security violation has been detected; and
determine that the error status register within a first of the plurality of hardware devices includes a value indicating that the security violation has been detected.

20. The computer readable medium of claim 19, which when executed by one or more processors, further cause the processors to:
transmit a cryptographically protected message to the host indicating that the first hardware device has detected the security violation; and
facilitate an exit of the first hardware device from the trusted I/O operational state.
